(19) United States
(12) Patent Application Publication
(10) Pub. No.: US 2014/0135447 A1
(43) Pub. Date: May 15, 2014

(54) PREPARATION OF IMIDE OLIGOMERS

(71) Applicants: Joseph C. Golba, Avon Lake, OH (US); Thomas W. Hughes, Aurora, IL (US); Roger W. Avakian, Solon, OH (US)

(72) Inventors: Joseph C. Golba, Avon Lake, OH (US); Thomas W. Hughes, Aurora, IL (US); Roger W. Avakian, Solon, OH (US)

(73) Assignee: POLYONE CORPORATION, Avon Lake, OH (US)

(21) Appl. No.: 14/130,842

(22) PCT Filed: Jul. 3, 2012
(86) PCT No.: PCT/US2012/045408

§ 371 Date: Jan. 3, 2014

Related U.S. Application Data
(60) Provisional application No. 61/625,795, filed on Apr. 18, 2012.
(60) Provisional application No. 61/504,692, filed on Jul. 5, 2011.

(51) Int. Cl. C08G 73/10; C08K 7/02; B29C 47/00; C08K 5/01

(52) U.S. Cl. CPC C08G 73/1028; C08K 5/01; C08K 7/02; B29C 47/004
USPC 524/592; 528/127; 528/189; 528/185; 528/229; 528/220; 528/339; 524/848; 524/600; 264/210.1

(57) ABSTRACT

Reactive extrusion can be used in a continuous, solvent-less preparation of imide oligomers involving two competing reactions among three ingredients, the first reaction between a dianhydride and a diamine and the second reaction between an endcap and the diamine. The imide oligomer can form a composite via conventional production methods or via formation of a film from imide oligomer re-melted in an extruder before being impregnated into tape or fabric.

### CLAIM OF PRIORITY

This application claims priority from U.S. Provisional Patent Application Ser. No. 61/504,692 bearing Attorney Docket Number 12011014 and filed on Jul. 5, 2011 and U.S. Provisional Patent Application Ser. No. 61/625,795 bearing Attorney Docket Number 12012002 and filed on Apr. 18, 2012, both of which are incorporated by reference.

### FIELD OF THE INVENTION

This invention concerns the production of low-melt viscosity imide oligomers from dianhydrides and diamines.

### BACKGROUND OF THE INVENTION

High performance imide polymers are characterized by excellent thermal stability, solvent resistance and high glass transition temperatures (Tg). U.S. Pat. No. 7,015,304 (Chuang), the disclosure of which is incorporated by reference, discloses the preparation by a batch process of solvent-free, low-melt imide oligomers and thermosetting polyimides, and to the process of preparing such oligomers and polyimides.

### SUMMARY OF THE INVENTION

Unfortunately, preparation of high performance imide polymers are difficult reactions and can benefit from reactive extrusion, a continuous process with timed introduction of the ingredients to form the imide oligomer taught in U.S. Pat. No. 7,015,304 (Chuang).

As explained in Chuang, the special feature of the Chuang invention was the novel combination of the reactants comprising dianhydrides selected from the group consisting of 2,3,3′,4′-biphenyldianhydride (a-BPDA), 2,2′,3,3′-biphenyldianhydride, 2,3,3′,4′-benzophenone dianhydride (a-BTDA), 3,4′-oxydiphthalic anhydride, 3,4′-methylenedipthalic anhydride, 4,4′-hexafluoroisopropylidene) diphthalic anhydride (HFDA), 4,4′-oxydiphthalic anhydride, and 3,3′-oxydiphthalic anhydride together with the specific group of diamines and the endcaps that can be melt-processed at temperatures between 232-270° C. (450-520° F.), without any solvent. This reaction produces imide oligomers that have low-melt viscosities of 1-60 poise at 260-280° C. The resulting imide oligomers are amenable to resin transfer molding (RTM), vacuum-assisted resin transfer molding (VARTM) or resin infusion processes at 260-280° C. to produce high quality polymer composites comprising carbon, glass, quartz or synthetic fiber preforms for use at temperatures ranging from about 288-343° C. (550-650° F.).

As further explained in Chuang, a preferred reaction formulation comprised asymmetrical dianhydrides selected from the group consisting of 2,3,3′,4′-biphenyldianhydride (a-BPDA), 2,3,3′,4′-benzophenone dianhydride (a-BTDA), 3,4′-methylenediphthalic anhydride, and 3,4′-oxydiphthalic anhydride with one or more of the specific diamines and 4-phenylethynylphthalic anhydride (PEPA) or nadic anhydride as the reactive endcap. These compounds could be reacted in the melt to produce imide oligomers that yield a very low viscosity (1-60 poise). This unique melt process, free of solvent, afforded a simple manufacturing advantage in terms of cost saving by not requiring expensive, high boiling solvents such as N-methyl-2-pyrrolidinone (NMP) to dissolve the monomers in order to produce the oligomers followed by a tedious and costly solvent removal process.

In order to produce imide oligomers having the low-melt viscosities, Chuang taught that specific aromatic dianhydrides were selected from the group consisting of 2,3,3′,4′-biphenyldianhydride (a-BPDA), 2,3,3′,4′-benzophenone dianhydride (a-BTDA), 3,4′-methylenediphthalic anhydride, 3,4′-oxydiphthalic anhydride (a-ODPA), 2,2′,3,3′-biphenyldianhydride, 4,4′-(hexafluoroisopropy lidene)diphthalic anhydride, 4,4′-oxydiphthalic anhydride, and 3,3′-oxydiphthlic anhydride. Chuang also taught that the specific diamines were selected from the group consisting of diamines containing two benzene rings; such as 3,4′-diamino diphenylmethane, 3,3′-diaminodiphenyl methane, 3,4-diaminobenzophenone, 3,3′-diaminobenzophenone, 3,4′-oxydianiline 2,2′-diamino biphenyl, 2,2′-dimethylbenzidine, 2,2′-bis(trifluoromethyl) benzidine, and diamines containing three benzene rings with linkages between the benzene rings. The linkage between the benzene rings are the same or different and include CH₂, C₂H₄, oxygen, nil or C═O. The amino group on the first benzene ring can be in the para, meta or ortho positions with respect to the linkage Y between the benzene rings while the second amino group on the second benzene ring is preferred to be in the meta or ortho positions with respect to the linkage. In case of three benzene ring diamines, the third benzene ring can be in para, meta or ortho positions.

The novel feature of the Chuang invention was based on the fact that the monomers, namely; the dianhydrides, diamines and the endcaps are melt processable which formed imide oligomers at temperatures ranging between 232-280° C. (450-535° F.) without any solvent. Furthermore, the imide oligomers either partially or fully imidized generally had low-melt viscosities in the range of 1-60 poise. These low-melt imide oligomers could be processed easily by resin transfer molding (RTM), vacuum-assisted resin transfer molding (VARTM) or the resin infusion process with preforms including carbon, glass, quartz or synthetic fibers to produce polyimide matrix composites with 288-343° C. (550-650° F.) high temperature performance capability.

The solvent-free melt-process provides a more consistent quality control in contrast to frequent contamination of high boiling NMP in the final resin product. An example of the solvent-free process is illustrated by the reaction seen at Columns 7 and 8 of U.S. Pat. No. 7,01.5,304 (Chuang).

However, all examples in Chuang disclosed a batch process in which the reactive endcap Elf PEPA was melt-processed with the dianhydride and the diamine from the beginning of the process, concurrently with the first contact between the dianhydride and the diamine which were supposed to react. In other words, the diamine reactions sites were in competition between the dianhydride and the endcap from the beginning of the process.

It is believed that reactive extrusion will result in a more controlled preparation of the low-melt imide oligomers invented by Chuang, while retaining the important features of a solvent-free melt-process preparation asserted by Chuang to be a significant advance in the art.

One aspect of the present invention is a process for preparing low-melt viscosity imide oligomers derived from a solvent-free reaction of stoichiometric effective amounts of at least one asymmetric dianhydride having the formula:

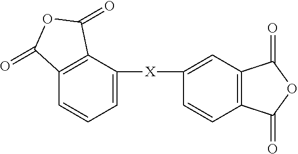

wherein X is selected from the group consisting of nil, C═O, —CH₂ and oxygen,

and at least one aromatic diamine having the formula:

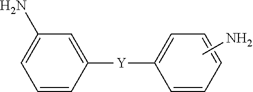

wherein Y is a aromatic radical selected from the group consisting of

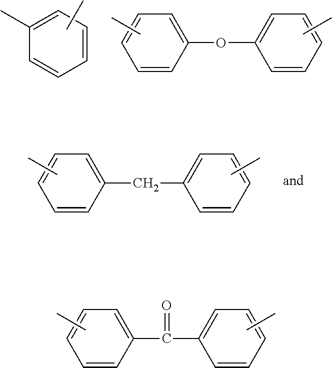

and an endcap selected from the group consisting of 4-phenylethynylphthalic anhydride and cis-5-norbornene-endo-2,3-dicarboxylic anhydride,

wherein the process comprises the steps of:

(a) introducing the asymmetric dianhydride and the aromatic diamine into an extruder at its throat;

(b) melt mixing the asymmetric dianhydride and the aromatic diamine for a sufficient period of time in at least one mixing zone to thoroughly blend them together;

(c) introducing the endcap into the extruder at a zone downstream from the throat and the mixing zone;

(d) melt mixing the asymmetric dianhydride, the aromatic diamine, and the endcap for a sufficient period of time in at least one mixing zone to permit reaction of them to form the imide oligomer; and

(e) extruding the imide oligomer from the extruder.

Embodiments of the invention are explained with reference to the drawing.

### BRIEF DESCRIPTION OF THE DRAWING

FIG. 1 is a schematic view of the reactive extrusion process of the invention.

### EMBODIMENTS OF THE INVENTION

Ingredients for Preparing the Imide Oligomers

Asymmetric Dianhydride

The asymmetric dianhydride has the formula:

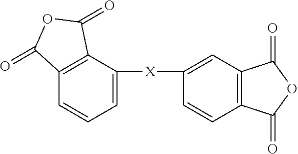

where X is selected from the group consisting of nil, C═O, —CH₂ and oxygen. Non-limiting examples of the asymmetric dianhydride include 2,3,3′,4′-biphenyltetracarboxylic dianydride (a-BPDA), 2,3,3′,4-benzophenone dianhydride (a-BTDA), 3,4′-methylene diphthalic anhydride (a-MEDA) or 3,4′-oxydiphthalic anhydride (a-ODPA), or combinations thereof dianhydrides selected from the group consisting of 2,3,3′,4′-biphenyldianhydride (a-BPDA); 2,2′,3,3′-biphenyldianhydride; 2,3,3′,4′-benzophenone dianhydride (a-BTDA); 3,4′-oxydiphthalic anhydride (a-ODPA); 3,4′-methylenedipthalic anhydride (a-MEDA); 4,4′-hexafluoroisopropylidene diphthalic anhydride (HFDA), 4,4′-oxydiphthalic anhydride; 3,3′-oxydiphthalic anhydride; and combinations thereof.

Diamine

The diamine can be a chemical having the formula:

and at least one aromatic diamine having the formula:

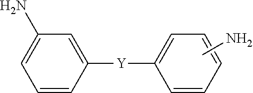

wherein Y is a aromatic radical selected from the group consisting of

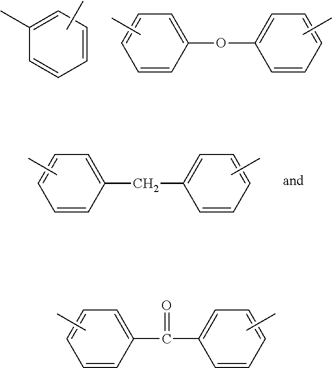

The diamine is subjected to end-capping to minimize over-reaction of the dianhydride with the diamine.

Endcap

The endcap is selected from the group consisting of 4-phenylethynylphthalic anhydride (PEPA), cis-5-norbornene-endo-2,3-dicarboxylic anhydride, and combinations thereof.

Optional Additives

As reported by Chuang, optionally, additives can be mixed with the imide oligomer. Non-limited examples of additives are selected from the group consisting of 4-phenylethynyldiphenyl methane and diphenylacetylene, and combinations of them. These additives can be added over the stoichimometric equivalents of the diamine and dianhydride to increase the glass transition temperature and thermo-oxidation of thermoset polyimide resins prepared from the imide oligomer.

Sequential, Reactive Extrusion

Significant to the invention is the delayed contact of the endcap with the diamine, in order to permit the diamine to melt-mix with the dianhydride in the early or upstream zones of an extruder. The melt-mixing of the dianhydride and the diamine can result in reaction, before the endcap is introduced into the extruder.

The delayed addition of the endcap can permit the initial formation of the imide oligomer, before the amine functionality of the diamine is removed from possible interaction and reaction with the anhydride functionality of the dianhydride.

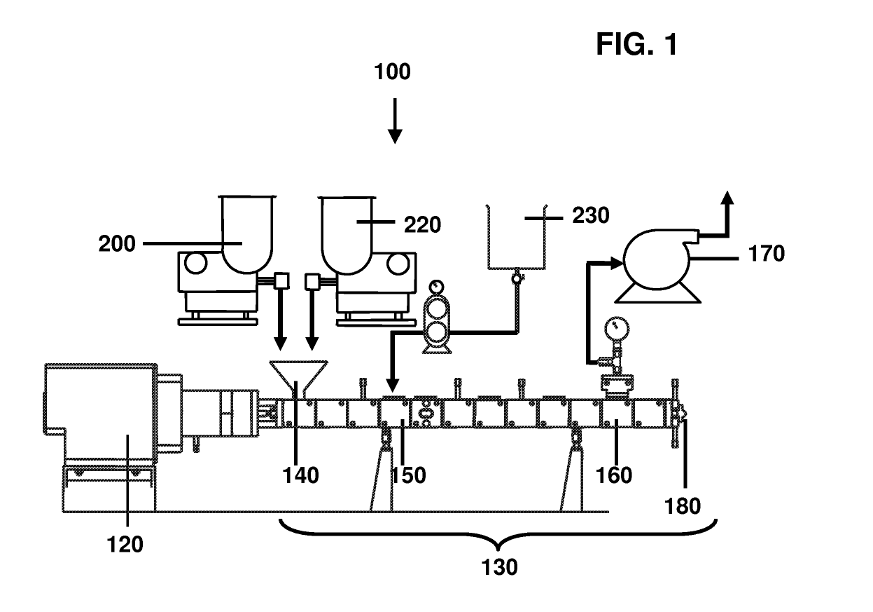

FIG. 1 provides a schematic view of the reactive extrusion method useful for the imide oligomer.

The process can be based on the use of an extruder 100 having a source of power 120 and a series of heated zones 130 through which ingredients travel in a molten state. The extruder can be a twin screw extruder, either co-rotating or counter-rotating and have a screw diameter ranging from 16 mm to 45 mm.

The series of heated zones 130 can number more than six and usually eight or nine, allowing the establishment of different temperatures associated with different segments of screws (not shown) propelling the molten ingredients through the extruder and encountering other ingredients in conditions ripe for planned reaction. FIG. 1 shows twelve zones 130 for extruder 100.

Among the series of zones is a first unheated or cooled zone or throat 140 of the extruder, into which some of the ingredients are added. A subsequent or downstream zone 150 contains a port for injection of at least one other ingredient. After the last ingredient(s) is(are) added at zone 150, further melt-mixing and planned reaction occurs, until an evacuation zone 160 is reached further downstream. Zone 160 can be connected to a source of vacuum power 170 to vent any volatiles, such as water or steam. The melted, mixed, and reacted product of the extruder 100 is extruded through a die 180, for further processing such as pelletizing for later melt-mixing or reaction.

In the present invention, the reactive extruder 100 can be configured to have a first feeder 200 and a second feeder 220 to introduce the dianhydride and the diamine, respectively, into the throat 140, commencing the journey through the extruder in which the early or upstream zones are heated to both melt the two ingredients and to facilitate a reaction between them, in the absence of any other ingredient, especially the endcap ingredient.

At a later zone, preferably about the fourth zone, shown as 150 in FIG. 1, the endcap can be introduced, in the sequence after sufficient time has passed at a given melting temperature to have permitted the dianhydride and the diamine to have begun reacting. The endcap can be a solid or a liquid, preferably, the latter to assist in the introduction into an already-melted and currently reacting mix of the dianhydride and the diamine.

The endcap is not believed to be able to cause an immediate cessation of that reaction underway at the fourth zone, but the delay in addition of the endcap, directly contrary to the disclosure of Chuang, is believed to be necessary to facilitate a better reaction between the dianhydride and the diamine to form the imide oligomer.

The reaction temperature, as reported by Chuang for a batch process, can range from about 232° to about 280° C. In this invention, each of the zones of the reactive extruder can be heated to a temperature within that range. Conventionally, the temperature remains the same or increases for the sequential zones, until the die zone 180, at which the same or slightly lower temperature prepares the extrudate for exit from the extruder and cooling into strands, pellets, etc.

Those persons having ordinary skill in the art of reactive extrusion, without undue experimentation, can select the appropriate temperatures for the zones within the range taught by Chuang. Also, those same persons, without undue experimentation, can establish screw rotation revolutions per minute to establish the time of transit through each zone of the extruder 100, which can be a factor in the kinetics of the reactive extrusion planned for the dianhydride and diamine before and after the delayed introduction of the endcap.

Significant to this invention is the establishment of delay in the introduction of the endcap, in order that the dianhydride and diamine, in the zones between zone 140 and zone 150 can commence reaction to then be exposed to the purpose of the endcap to compete and deny reaction sites at the diamine for reaction by the dianhydride.

Imide oligomers produced by the reactive extrusion process should result in the same end product as taught by Chuang, such as having a low-melt viscosity of about 1-60 poises at 260°-280° C. and a cure glass-transition temperature of about 310°-380° C.

Usefulness of the Invention

A better controlled, solventless, continuous reactive extrusion to form imide oligomers disclosed by Chuang, could make the imide oligomers more cost effective for the preparation of composites of the imide oligomer and other ingredients, including the optional additives listed above.

The imide oligomer formed by the sequential reactive extrusion process of this invention can be further reacted or cured in the presence of a fiber preform at temperatures ranging from about 343° to 371° C. to obtain a thermosetting polyimide matrix-composite having a Tg ranging from about 310°-380° C. The preform can be carbon, glass, or a synthetic fiber preform. The means of curing can be a resin-transfer molding process.

Composites so formed can be used in a number of high performance articles, such as lightweight polymer composites (e.g., airframe and engine components); military and commercial aircraft; missiles, radomes, and rockets, etc.; high temperature laminates; electrical transformers; bushings/bearings for engines; oil drilling equipment; oil drilling risers; automotive chassis bearings; and films for use in electronics, fuel cells and batteries.

One embodiment of forming a composite from imide oligomer solves problems with the production of polyimide prepregs or preforms.

This conventional production currently relies on the melting of solid resins in heated feed tanks, transfer of the melt to a three-roll mill type feeding system, production of a thin film on a roller, and then transfer of the film to a uni-dimensional tape or a fabric which can be made of carbon fibers, fiberglass, and polymers, such as Kevlar™ brand polymer, or combinations of them. This conventional production requires that these imide oligomeric thermoset resins be stored at elevated temperatures for long periods of time in the heated feed tanks, which can allow those resins to begin their cross-linking chemical reactions before being rolled into films for laminated composite construction.

At best, it is estimated that the current production method allows only for a short “pot life” of one to two hours for those resins in the heated tanks before they need to be discarded as no longer reliable or viable reactive polymer systems.

The new production of composites begins with the solvent-less reactive extrusion process described above, which has resulted in polyimide oligomers in the form of dry powders, pellets, filaments, films, etc. The production utilizes powder or pellets of the imide oligomer to be fed as solid articles into a single screw extruder with an appropriate film or sheet extrusion die and operating at temperatures above the melting point of the imide oligomer. The extruder would rapidly melt the dry oligomer to produce a thin film emerging from the die, which would then be fed directly into the prepreg or preform machine for impregnation into the tape or fabric, such machine as described in U.S. Pat. No. 7,297,740 (Dyksterhouse).

The use of an extruder to re-melt the powder or pellets of imide oligomer dramatically reduces the time during which those imide oligomer resins are exposed to elevated temperatures. It is probable that the total time from feeding of powder or pellets into the extruder to impregnation into the uni-dimensional tape or fabric will be only a few minutes, during which time the imide oligomer will have a very limited chance to react inadvertently until the time is proper in the prepreg machine.

The invention is not limited to above embodiments. The claims follow.

What is claimed is:

1. (canceled)

2. The process of claim 17, wherein the temperature in the extruder ranges from about 232° to about 280° C.

3. The process of claim 17, wherein step (c) uses an injection port and step (d) uses an evacuation port.

4. The process of claim 17, wherein step (e) results in pelletization for further processing.

5. The process of claim 17 wherein the endcap introduced during step (c) competes and denies reaction sites at the aromatic diamine for reaction by the dianhydride.

6. The process of claim 17 wherein establishment of delay in the introduction of the endcap of the extruder during step (c) permits the dianhydride and the diamine to commence reaction during step (b) followed by exposure during step (d) to permit the endcap to compete and deny reaction sites at the diamine for reaction by the dianhydride.

7. The process of claim 17, wherein step (c) occurs after sufficient time has passed at a given melting temperature to have permitted the dianhydride and the diamine to have begun reacting during step (b).

8. The process of claim 17, wherein the endcap is a solid or a liquid, and wherein the process is solvent-less.

9. The process of claim 17 wherein the introduction of the endcap during step (c) does not cause immediate cessation of reaction of the dianhydride and the diamine which have begun reacting during step (b).

10. The process of claim 17, wherein the imide oligomer further comprises optional additives selected from the group consisting of 4-phenylethynyldiphenyl methane and diphenylacetylene, and combinations of them.

11. The process of claim 17, further comprising the steps of:
(f) re-melting the imide oligomer in an extruder;
(g) extruding the re-melted imide oligomer in the form of a film; and
(h) feeding the film into a machine for impregnation into a tape or fabric.

12. The process of claim 11, wherein the tape or fabric comprises carbon fibers, fiberglass, polymers, or combinations of them.

13. A composite formed from the imide oligomer made by the process of claim 17.

14. The composite of claim 13, wherein the imide oligomer is further reacted or cured in the presence of a fiber preform at temperatures ranging from about 343° to 371° C. to form a thermosetting polyimide matrix-composite having a Tg ranging from about 310°-380° C.

15. The composite of claim 14, wherein the preform can be carbon, glass, or a synthetic fiber.

16. The composite of claim 13, wherein the composite is in the form of an article selected from the group consisting of an airframe component; an engine component; an aircraft; a missile; a radome; a rocket, a high temperature laminate; an electrical transformer; an engine bushing; an engine bearing; oil drilling equipment; oil drilling risers; automotive chassis bearings; and films for use in electronics, fuel cells and batteries.

17. A process for preparing low-melt viscosity imide oligomers derived from a solvent-free reaction of stoichiometric effective amounts of at least one asymmetric dianhydride having the formula: 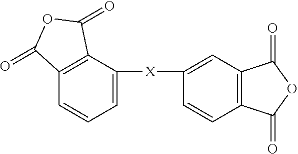
wherein X is selected from the group consisting of nil, C═O, —CH₂ and oxygen,
and at least one aromatic diamine having a formula selected from the group consisting of: 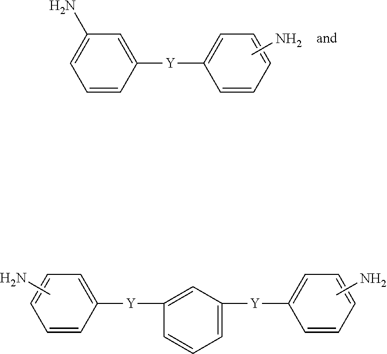
wherein the Y radicals are either the same or different and are selected from the group consisting of nil, CH₂, C₂H₄, C═O, and oxygen,
and a reactive end-cap selected from the group consisting of 4-phenylethynylphthalic anhydride and cis-5-norbornene-endo-2,3-dicarboxylic anhydride,
wherein the process comprises the steps of:
(a) introducing the asymmetric dianhydride and the aromatic diamine into an extruder at its throat;
(b) melt mixing the asymmetric dianhydride and the aromatic diamine for a sufficient period of time in at least one mixing zone to thoroughly blend them together;
(c) introducing the endcap into the extruder at a zone downstream from the throat and the mixing zone;
(d) melt mixing the asymmetric dianhydride, the aromatic diamine, and the endcap for a sufficient period of time in at least one mixing zone to permit reaction of them to form the imide oligomer; and
(e) extruding the imide oligomer from the extruder.
